(19) United States
(12) Patent Application Publication
(10) Pub. No.: US 2017/0060951 A1
(43) Pub. Date: Mar. 2, 2017

(54) POINT SEARCH - A SOCIAL SEARCH METHOD FOR FINDING PEOPLE

(71) Applicant: MIHAI EUGEN MASALA, Deep River (CA)

(72) Inventor: MIHAI EUGEN MASALA, Deep River (CA)

(21) Appl. No.: 15/247,927

(22) Filed: Aug. 26, 2016

Related U.S. Application Data
(60) Provisional application No. 62/212,598, filed on Sep. 1, 2015.

(51) Int. Cl. G06F 17/30

(52) U.S. Cl. CPC G06F 17/30477; G06F 17/30283; G06F 17/30312

(57) ABSTRACT

Point Search is a device, system and method of social search wherein currently disconnected people can get in contact by making a search on a common point, where the point can be a circumstance, location, event etc. Point Search applies to a variety of relationships between people that seek to get in contact, including: people that had a strong relationship of any kind, at any time in the past, but which people are currently disconnected and with no contact reference to each other; strongly related people that are currently disconnected by external circumstances (natural disasters, abductions, wars, social unrests, quarantines etc.); disconnected and unrelated people, but sharing a same location, event, interest or circumstance at the same time; and other relationships, as it will become apparent from the detailed description of this invention.

### CROSS REFERENCE TO RELATED APPLICATIONS

This application claims the benefit of provisional patent application Ser. No. 62/212,598 filed on Sep. 1, 2015.

### BACKGROUND

The emergence of the social networks in the first decade of the 21^{st} century was probably the most spectacular development among all internet technologies, with huge implications in the ways people use to communicate. While the social network services continue to develop and increase in popularity, in the recent years however there haven't been radical advances in this technology, this lack of innovation in the field leaving the competing social networks wrestling rather by brute force on mostly common grounds.

One of the aspects that the social networks currently lack and need to bring new developments to is the capability of connecting people that are, or have been, related to each other, at a very personal level in most of the cases, but are currently completely disconnected, with no reference to each other and therefore virtually no possible way to find each other with the existing capabilities of the current social networks. Therefore, it is with respect to these considerations and others that the present invention has been made.

### SUMMARY

The present invention is directed to a social search method that meets these needs. The social search method, herein called Point Search, involves two or more currently disconnected users, with no direct reference to each other, that connect to each other by performing a search on a common point, not necessarily concurrently, where the point can be a circumstance, location, event, among others.

In a particular embodiment of the Point Search method, hereafter called Find You, two people that shared a common particular circumstance for a definite closed period of time in the past that resulted in a strong mutual relationship of any kind, but which people completely disconnected after that past circumstance ended, up to the present moment, decide to search for each other, not necessarily concurrently. The Find You embodiment of the Point Search method can also apply to momentary present encounters between the two people, as well as to continuing present encounters, as it will be described in the detailed description section. The Find You embodiment works on the grounds that the two mutually searching people have no direct references to each other, and therefore no established methods of searching for each other directly with the capabilities offered by the existing social networks. The searching process comprises a mutual indirect search request from both users, not necessarily concurrently, by means of a social network for example. Since the two users are disconnected and have no reference to each other, they cannot search directly for each other. Rather, the mutual search is performed on common characteristics of the particular circumstances of the encounter that resulted in the strong relationship between the two users, such as precise or approximate date and location at a minimum, as well as first or last name, or both, of the sought user, if known. The search request may include more particular characteristics of the circumstances in order to support the searching algorithm for a more precise match. In the process, one of the two users makes a first search request for the other user, which request is sent to the social network server where it is stored and awaits a similar search request from the other user, on common characteristics such as date, location and name among others. At this point, the user being searched for is not aware that a search request has been performed for him/her. At the subsequent time when the second user decides to perform a search request for the first user, based on the same common circumstances, this search request is sent to the server, where the searching algorithm, while comparing all search requests stored from all other users using the Find You embodiment, can match the search requests from both users, based on the common searching characteristics, at which point both users are notified of the match and the connection between the two users is easily established. The described process of the Find You embodiment of the Point Search method requires a mutual desire from both users to find each other in order to complete the connection. The process also requires that the users are aware of this searching service so they can use it, but this would not be an impediment since the service can be easily promoted to the public through a social network. Because the Point Search process is not a direct search by a user for another user, but rather an indirect search focused on a common point, this search process is opaque in the sense that a search request from a user for another user will never be acknowledged by the sought user unless the sought user searches back for the searching user. The Find You embodiment works on long past encounters, as well as recent encounters, present encounters or even continuing encounters or future encounters, as it will be described in a subsequent section of this disclosure. The Find You embodiment of the Point Search method provides a means to connect people, under the described circumstances, that no existing social network or service can currently provide.

In another particular embodiment of the Point Search method, hereafter called Find Group, multiple people that shared a common group for a definite closed period of time in the past that resulted in strong relationships of any kind between the members of the group, but which people completely disconnected after the group activity ceased, up to the present moment, decide to search for each other, not necessarily concurrently. Since the group users are disconnected and have no reference to each other, they cannot search directly for each other. Rather, the mutual search is performed on common characteristics of the particular circumstances and activities of the group that resulted in the strong relationship between the group users, such as precise or approximate date and location at a minimum, as well as name of the sought users, if known. The searching process associated with the Find Group embodiment is similar to the one for the Find You embodiment described above, with added complexity, on the server side of the process, associated with the larger number of users searching for the group. The group can be based on long-term relationships between members sharing a same neighborhood, a same sport/educational/artistic team, or other such groups involving long-term common activities sometime in the past. Other groups can be based on short-term activities, such us memorable competitions, camps or events of any kind.

In another particular embodiment of the Point Search method, hereafter called Distress Search, strongly related people that are currently disconnected due to a certain form of distress can reconnect with each other through the Point Search method. The distress can be a natural disaster such as an earthquake/tsunami, a war, social unrest, quarantine, even abduction or others of the sort. The Distress Search embodiment of the Point Search method is similar to the Find You embodiment described above, with certain differences that will become apparent during the detailed description of this invention.

In another particular embodiment of the Point Search method, hereafter called Position Search, a person using this special service can search for other people, to which the searching person is neither connected, nor previously related, by a Point Search based on the current location of the searching person. A person sharing a same approximate location at the same time with other people has commonalities with these people based on this same location. As such, the searching person can use his mobile phone, or any other wearable devices, such as glass or watch, to try to get in contact with the people close by, by sending a written or verbal request to a centralized server, in form of a question or message about the common surroundings or events or anything of this sort. The close by people having the Position Search service active on their mobile device will receive a notification from the server that a close by person is sending a request out, and can opt to read/hear this request. Upon acknowledging the request, the people receiving the message can decide to respond to the inquiring person, and a communication line can be directly open between the two users, or indirectly through the Position Search server. Multiple lines of communication can be open between the inquiring user and more responding users. The Position Search embodiment of the Point Search method includes a wide variety of common position circumstances involving common activities by the users, such as attending social events (sports, concerts, festivals or anything of the sort), driving a highway, shopping in a mall, among many others.

Other embodiments of the Point Search method will be presented in the Detailed Description section or in the Use, Advantages and Examples section of this disclosure. These embodiments include the Lost and Found, Point Classifieds, Point Map and Point Search for Anything methods.

Other implementations of one or more of these embodiments include corresponding systems, apparatus, and computer programs, configured to perform the actions of the methods, encoded on computer storage devices. These and other features, aspects, and advantages of the present invention will become better understood with reference to the following description.

### BRIEF DESCRIPTION OF THE DRAWINGS

Non-limiting and non-exhaustive embodiments of the present invention are described with reference to the following drawings. For a better understanding of the present invention, reference will be made to the following Detailed Description section of this disclosure, which is to be read in association with the accompanying drawings, wherein:

FIG. 1a illustrates a logical flow diagram generally showing the social search process associated with the Find You embodiment of the Point Search method.

FIG. 1b illustrates the continuation of the logical flow diagram of FIG. 1a.

FIG. 2a illustrates a logical flow diagram generally showing the social search process associated with the Find Group embodiment of the Point Search method.

FIG. 2b illustrates the continuation of the logical flow diagram of FIG. 2a.

FIG. 3 illustrates a logical flow diagram generally showing the social search process associated with the Position Point Search embodiment of the Point Search method.

FIG. 4 illustrates a logical flow diagram generally showing the social search process associated with the Lost and Found embodiment of the Point Search method.

FIG. 5 illustrates a logical flow diagram generally showing the social search process associated with the Point Classifieds embodiment of the Point Search method.

### DETAILED DESCRIPTION

The Point Search method, together with the embodiments presented in this disclosure, will be described more fully hereinafter with reference to the accompanying drawings, which form a part hereof, and which show, by way of illustration, specific embodiments of the invention. However, this invention may be embodied in many different forms and should not be construed as limited to the embodiments set forth herein. Rather, these embodiments are provided so that this disclosure will be thorough and complete, and will fully convey the scope of the invention to those skilled in the art. Among other things, the present invention may take the form of an entirely hardware embodiment, an entirely software embodiment or an embodiment combining hardware and software aspects. Therefore, the following detailed description is not to be taken in a limiting sense.

Throughout this disclosure, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to the same embodiment, although it may. Thus, as described below, various embodiments of the invention may be readily combined without departing from the scope or spirit of the invention.

As used herein, the term “connected”, used in relative relation between two users, refers to the status of the two users having direct reference to each other, for example by means of a social network, by which the users can get in direct communication. Similarly, the term “disconnected” refers to the status of two users lacking a direct reference to each other, therefore totally lacking the possibility of getting in direct communication with each other.

As used herein, the term “related”, used in relative relation between two users, refers to the status of the two users having something in common: they may know each other, or they may share a same interest or circumstance. Two related users may not necessarily be connected in the sense of the definition of the term “connected” provided above.

As used herein, the term “one-to-one” refers to a type of communication between two known (therefore related) users, or a type of search between two known users for each other.

As used herein, the term “one-to-group” refers to a type of communication between one specific user and multiple known (therefore related) users sharing a group, or it refers to a type of search by the specific user for the known users of the group.

As used herein, the term “one-to-many” refers to a type of communication between one specific user and multiple presently (but not previously) related but unknown users sharing an activity, circumstance etc., or a type of search by the specific user for the presently related but unknown users sharing an activity, circumstance etc.

As used herein, the term “point” refers to the object of a search performed by a user.

As used herein, the term “Point Search” refers to a social search method, by which two or more previously disconnected users make a search request for a common point, with the purpose of connecting with each other by means of this convergent, focused search on this common point.

To make the objectives, technical solutions, and advantages of the present disclosure clearer, the embodiments of the present disclosure are described in detail below with reference to the accompanying drawings.

### The Point Search Method

Point Search is a generic method for searching between people, whereby the users search for each other indirectly, by use of a common point, where the point can be a circumstance, location, event, among many other. Due to its versatility, this novel technique of searching can reach many different social aspects, hence the variety of the embodiments described in the following paragraphs. By its nature, the Point Search method is very suitable for implementation within a social network.

### Embodiment 1

In this embodiment of the Point Search method, herein called Find You, two related people that shared a common particular circumstance for a definite closed period of time in the past that resulted in a strong mutual relationship of any kind, but which people completely disconnected after that past circumstance up to the present moment, decide to search for each other, not necessarily concurrently. The Find You embodiment also applies to momentary present encounters between the two related people, as well as to continuing present encounters, as it will be described in the following sections.

For this embodiment of the Point Search method, the common point of the search process is therefore the particular circumstance of the encounter.

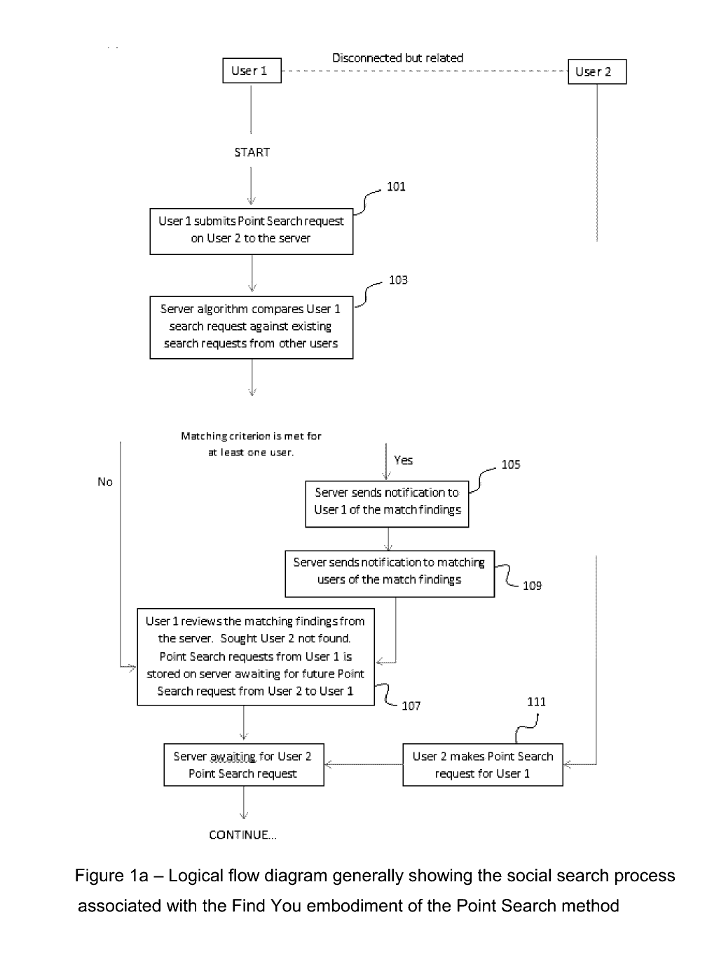

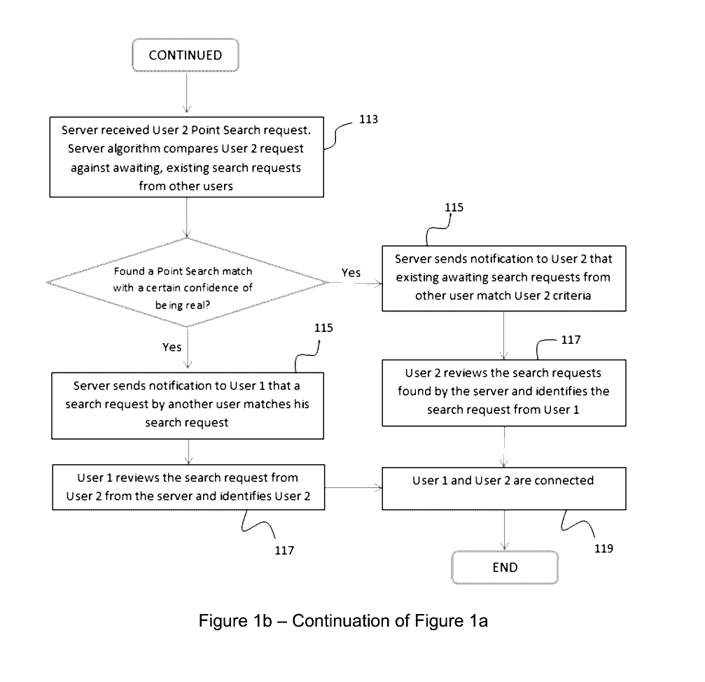

FIG. 1a and FIG. 1b illustrate the logical flow diagram generally showing the social search process associated with the Find You embodiment of the Point Search method. Referring to FIG. 1, this embodiment includes the following steps:

Step 101: User 1 decides to search for User 2, for which User 1 does not have any explicit reference such as exact full name or other descriptions that would make it possible to make a successful search with the current capabilities of the existing social networks. The success of this Point Search embodiment is based on common points that the two users have. With that in mind, User 1 submits a Find You search request on User 2, without knowing whether User 2 made a similar search request for User 1 or not, since this information is not available to User 1. In his/her search request, User 1 specifies as much common information as he/she knows: name of User 2 (if known), date and location of the encounter between the two users, as well as any specific information, submitted as regular text, related to the encounter between the two users that User 1 considers it was memorable enough that User 2 would also remember and use it in the search request for User 1 in return. This search request is submitted through a social network using the Find You embodiment of the Point Search method, to the social network server. As an example, the location can be submitted by User 1 by clicking the location on a map made available by the Find You server. User 1 also submits personal information that User 2 might inquire about in his/her search, such as name, physical description, among other particularities.

Step 103: Upon receiving the search request from User 1, the server executes the searching algorithm to compare the submitted search request from User 1 against all the existing search requests already sent by other users of the Find You embodiment and awaiting a connection. Pre-set search fields, such as both user names (if known for the sought user), as well as date and location of the encounter between the users (with specified precision), as entered by the searching users of the Find You embodiment, are compared against each other. Other specifics of the encounter, such as memorable actions, dialogs or circumstances of the encounter, that User 1 believes would also be searched for by User 2, are submitted in form of plain text. These text strings are also compared against the text strings submitted by other users in search for a match, by the server algorithm. Given the assumed large number of awaiting search requests on the server to be compared against, the search process can be optimized by first comparing the data in the pre-set search fields, such as date of the encounter, followed by location of encounter and names of User 1 and User 2 (in known). Upon this first stage of the search, a very restricted list of possible matches (if not empty at all), satisfying the matching criterion, is compiled and ordered for the second stage of the searching algorithm, dealing with the specifics of the encounter captured in text strings by the searching users. In order for a match between User 1 submitted search data and existing search data from other users to qualify as a possible true connection, a matching criterion has to be met, by which a minimum value of the matching coefficient, as calculated by the server algorithm, has to be exceeded.

Step 105: The server algorithm orders the final list of possible encounters, if not empty, by the matching coefficient and presents it back to User 1. Since the flow chart presented in FIG. 1 assumes that at this point in the process, User 2 had not yet submitted a search request for User 1, the matching list will not contain the sought User 2.

Step 107: User 1, upon receiving the matching list returned by the server algorithm, reviews this list and should easily realize that none of the matches is the sought User 2. However, if the search requests are too vague and do not contain enough details, there may be cases where User 1 could interpret some of the matches in the matching list as possible true connection to the sought User 2. In these cases, User 1 can send an anonymous message to the matching user and the connection can be clarified upon this message contact if true or not (at this point of the searching process as presented in FIG. 1, the connection is not the true one).

Step 109: Based on the matching list, if not empty, compiled by the server algorithm upon User 1 search request, notifications for a possible true connection are also sent by the server to all users in this matching list, by which these users are notified that a searching user just submitted a search request that satisfies the matching criterion and might therefore be the true connection to the user they had already searched for. As a result of these notifications, it is possible that User 1 may receive anonymous messages from these users, and the connection can be clarified upon this message contact if true or not (at this point of the searching process, as presented in FIG. 1, the connection is not the true one). It is therefore to be noted that for very specific search requests sent by the users (precise date and location should suffice), the matching criterion can be tightened so the limit for the matching coefficient is set by the server algorithm at a higher value. As a result, the list of possible true connections is very limited and likely to return the sought user if the sought user had already sent his search request for the searching user. In contrast, for vague search requests, the limit for the matching coefficient is set by the server algorithm at a lower value and therefore the list of possible true connections is larger.

A true connection was not found yet between searching User 1 and sought User 2, because at this point in the searching process flow chart, as presented in FIG. 1, User 2 had not yet submitted a search request for User 1. The search request from User 1 is stored on the server to be compared with subsequent search requests from other users.

Users other than sought User 2 submit their search requests looking for their own matches, different than User 1. With each search request received by the server from a user, that search request is compared with all existing stored search requests, including the search request from User 1 for User 2. Some of these comparisons might meet the matching criterion for User 1 (based on existing User 1 search request), and when this happens, a notification is sent to User 1 that a match to a possible true connection with sought User 2 was found. User 1 can follow up with anonymous messages with the matching user and realize this is not the sought User 2.

Step 111: At some indeterminate time after User 1 made his search request for User 2, User 2 decides to search for User 1, without knowing whether User 1 has already made a search request for User 2 or not, since this information is not available to User 2. User 2 therefore submits the Find You search request for User 1 to the server, with data such as date and location of encounter with User 1, together with their names (if known for User 1) and possibly other text strings describing memorable events or circumstances most representative for the past relationship between User 1 and User 2, that User 2 thinks would be used by User 1 in his search request, for a better match. Normally, date and location would suffice for the searching algorithm on the server to match the true connection between User 1 and user 2, if the encounter did not involve a major event attended by a large number of people.

Step 113: Upon receiving the search request from User 2 for User 1, the server algorithm compares this search request with all existing search request from all users and looks for a match.

Step 115: Upon finding the match between User 1 and User 2, the server sends the matching notification to both User 1 and User 2.

Step 117: Both User 1 and User 2 review the search request from the other user and decide, based on the high probability for a true connection, to follow up with anonymous messaging.

Step 119: The true connection between User 1 and User 2 is established. The users may decide to make their social network identity known to each other.

Although the searching process associated with the Find You embodiment may seem complicated, most steps of this process are performed on the server side and are invisible to the searching users. On the users' side, the actions are only limited to sending the search request and to subsequently reviewing the matches found by the server for a possible true connection, if any.

### Embodiment 2

In this embodiment of the Point Search method, herein called Find Group, two or more related people that were members of a same group for a definite closed period of time in the past that resulted in a strong relationship of any kind between the group members, but which people completely disconnected after the group activity ceased up to the present moment, decide to search for each other, not necessarily concurrently.

For this embodiment of the Point Search method, the common point of the search process is therefore the group.

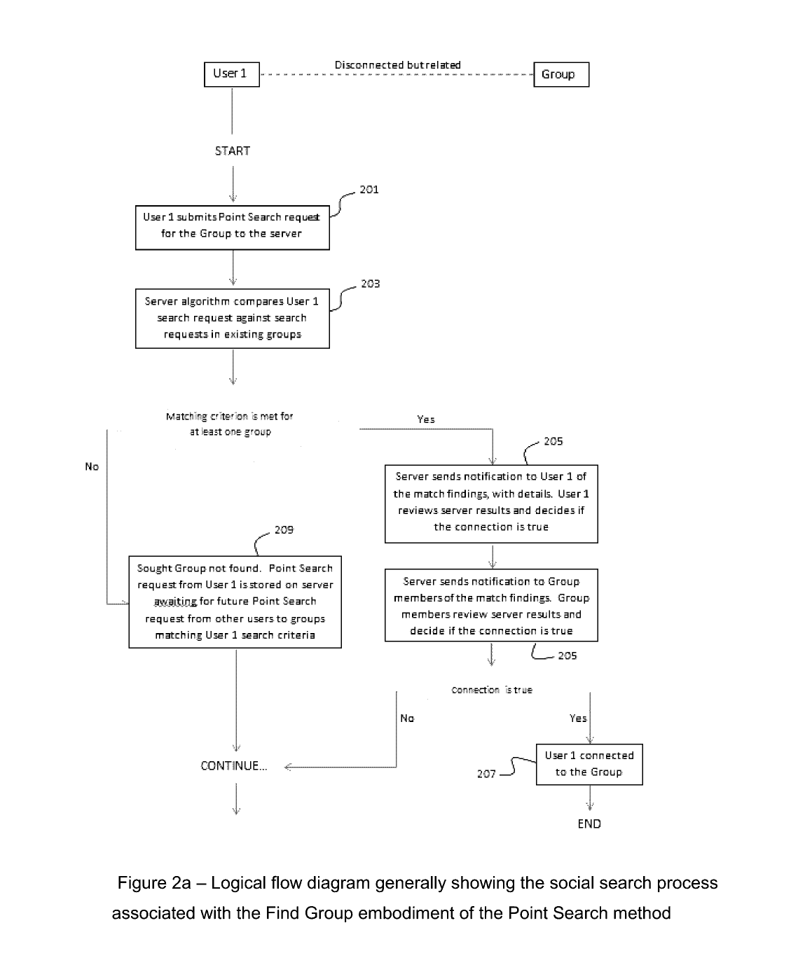

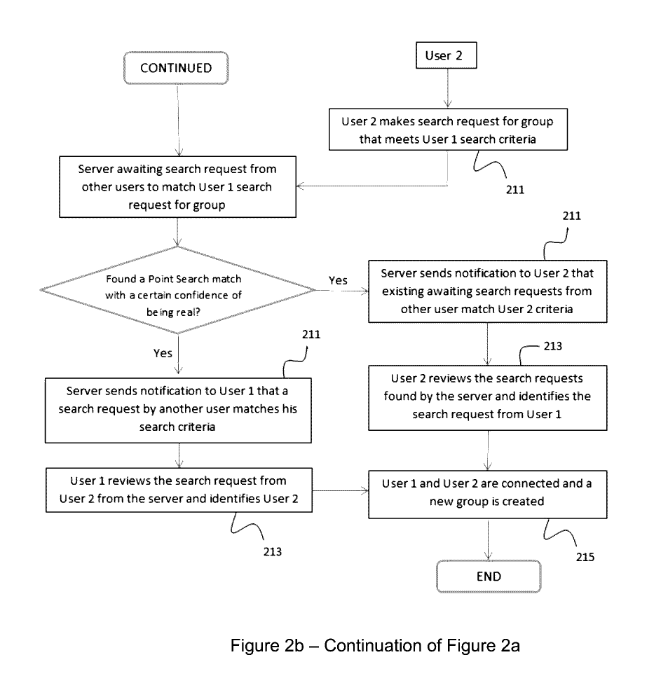

FIG. 2a and FIG. 2b illustrate the logical flow diagram generally showing the social search process associated with the Find Group embodiment of the Point Search method. Referring to these figures, the search process associated with the Find Group embodiment includes the following steps:

Step 200: Status of the server before User 1 makes the search request. There are existing established groups still open for searches from other members of that group. There are also existing search requests for groups from individual users that have not yet found their group.

Step 201: User 1 makes a Find Group search for the group by entering date (period), location, approximate number of group members, names of members (if known), activity of the group, memorable events of the group from pre-set fields. User 1 also enters other specifics of the group in text strings.

Step 203: Server first compares User 1 submitted data against search data from existing established groups.

Step 205: If the algorithm matching criterion for an existing group is satisfied, notification for possible true group connection is returned to User 1, and notification for possible user connection is sent to group members. If the matching criterion is not satisfied for an existing group, but for an existing group search request from another User 2, notification is sent to both User 1 and User 2.

Step 207: User 1 reviews server result and decides if the connection is true. If yes, the connection of User 1 with the sought group is established and the search process is completed.

If User 1 connected to his sought group, he will still receive future possible notifications from the server whenever a new searching user meets the group criteria, reviews the server return and decides (together with responses from other existing group members) whether the new searching user is a true connection to the group. If yes, the new user is added to the group.

Step 209: If the server return does not result in a true connection with an existing group, then User 1 search request data is stored for subsequent match attempts based on future user search requests.

Step 211: If at any time after User 1 submits his request, there is a new searching User 2 that matches User 1 data within the acceptance criterion, a notification is sent to both users.

Step 213: User 1 and matched User 2 review the server match data and decide if they have a true connection.

Step 215: If User 1 and User 2 have a true connection, then a new group is created by the server, comprising User 1 and the matched User 2. If not, the process goes back and User 1 request awaits new matches.

If a new group is created, User 1 will still receive match reports from the server when a new searching user meets the group criteria and decide whether the new searching user is a true connection.

Although the searching process associated with the Find Group embodiment may seem complicated, most steps of this process are performed on the server side and are invisible to the searching users. On the users' side, the actions are only limited to sending the search request for the group connection, and to subsequently reviewing the matches found by the server for a possible true connection, if any.

### Embodiment 3

In this embodiment of the Point Search method, herein called Distress Search, strongly related people that are currently disconnected due to a certain form of distress can reconnect with each other through the one-to-one Point Search of this service. The distress can be a natural disaster such as an earthquake/tsunami, a war, social unrest, quarantine, even an abduction or others of the sort.

For this embodiment of the Point Search method, the common point of the search process is therefore the circumstance of the distress.

The process flow associated with the Distress Search embodiment is very similar to the process flow of the Find You embodiment presented in FIG. 1 in which two users search for each other, with a few differences arising from the different common points of the search, resulting in different circumstances of these two embodiments. Since the users of the Distress Search service are currently strongly related, although disconnected, they know each other's names precisely. They also know the precise searching coordinates associated with the distress circumstances, such as date and location of the distress. Also, since this embodiment applies particularly to distress circumstances, another pre-set field for search is the type of distress, which could be a natural disaster such as an earthquake, tsunami or hurricane; it could also be an abduction, war, social unrest, quarantine or any other type of distress capable of disconnecting two strongly related users. These coordinates, due to their specificity, are sufficient for a perfect match by the server algorithm and therefore a true connection is guaranteed provided that both users search for each other by use of the Distress Search service.

Alternatively, for the particular case of the natural disasters, due to the very specific circumstances of this type of distress, the Distress Search embodiment could be implemented differently than for the other Point Search embodiments. Rather than using existing social network services, the Distress Search service for natural disasters could be implemented by post-disaster recovery agencies established at the disaster location and made available for anyone in need. As such, the Distress Search embodiment of the Point Search method described in this disclosure provides very effective means for disconnected people to reconnect quickly under extremely difficult conditions of a natural disaster, among other distress situations, especially in locations where communication is not readily available, or it is disrupted as a result of the natural disaster.

### Embodiment 4

In this embodiment of the Point Search method, herein called Position Search, a user using this special service can search for other users, to which the searching person is neither connected, nor previously related, in a one-to-many type of Point Search (in the sense of the definition provided in the Detailed Description section) based on the current location of the searching person. A person sharing a same approximate location with other people has commonalities with these people based on this same location. As such, the searching person can use his mobile phone, Google Glass, Apple Watch or any other mobile or wearable device to try to get in contact with the people nearby. The location shared by the users can be any public place in principle, such as a street in New York, but it can also be the place of a certain event, or a place where specific activities unfold, which makes connecting people even more appealing. As such, these places can be stadiums or arenas for sport events, concerts, festivals; they can be shopping malls, highways, dance clubs, vacation resorts, universities or institutions where specific activities are carried out; or any other such place that, by being shared by more people, makes these people likely to enter communication based on the fact that they are performing the same activity at the same time.

For this embodiment of the Point Search method, the common point of the search process is therefore the location of the users.

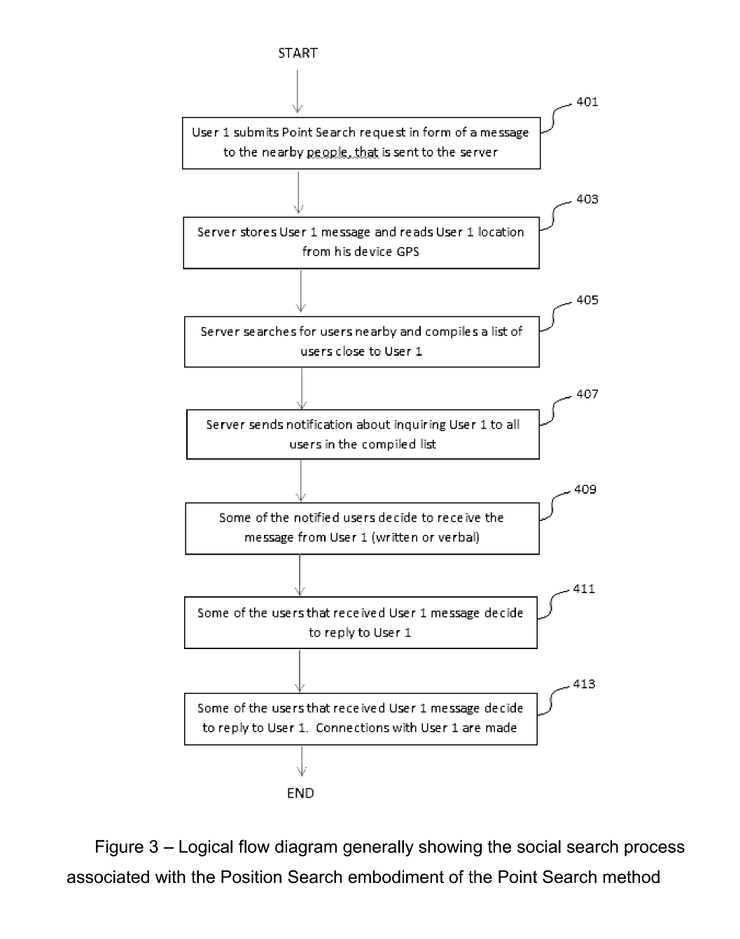

FIG. 3 illustrates the logical flow diagram generally showing the social search process associated with the Position Search embodiment of the Point Search method. Referring to FIG. 3, the search process associated with the Position Search embodiment includes the following steps:

Step 401: User 1 at location X decides to approach people nearby. User 1 uses the Location Search service of the social network he is using, by sending a message out to the people nearby. The message can be a written message, or a voice message.

Step 403: The message sent by User 1 is received by the Point Search server and stored temporarily. First, the location of the searching user is collected, as the message sent contains the location information collected automatically from the GPS service of the mobile device used by User 1. If the place User 1 is located at the time of sending the message is a public place, such a street in a city, the reaching area can be pre-set at a certain value around the searching user, for example 100 m. If, however, the place is a place where a certain event unfolds, such as a stadium, arena, university, highway etc, the searching location is determined automatically by the Point Search server and restricted to the perimeter of the local building/arena/highway/etc. This can be easily achieved since these public places are recognized with tools such as Google Maps, which offer API functions to access and process such information.

Step 405: The Location Search server searches for users nearby. The server can only have that location information for the users that have the Location Search service active on their mobile device at the time of User 1 search. For this service to be effective, it is therefore necessary to be used at a large scale within a social network, to ensure that at least one in a few requests from a user reaches other users nearby. Of course, in more populated places, such as sport events or busy streets, the probability for a contact increases. As a result of the search, the server compiles a list of users at the same approximate location with the searching User 1.

Step 407: The server sends a notification to all the users in the compiled contact list that a nearby user sent a message out.

Step 409: Users receiving the server notification decide to receive the message or not. If they decide to receive the message, they will read it or hear it (hearing a message would be more convenient on mobile devices such as Google Glass).

Step 411: If the user reading/hearing User 1's message decides to respond, he sends a message back to User 1, by submitting it to the Location Search server. Alternatively, the responding user may decide to enter direct communication with the searching user, although anonymously, through the text/voice messaging capability offered by the Location Search service of the hosting social network. At this point, the connection between User 1 and the responding user is established.

Step 413: There may likely be multiple Location Search users responding to a search request or message sent by a user.

### Embodiment 5

In this embodiment of the Point Search method, herein called Lost and Found, a disconnected and unrelated pair of users, User 1 and User 2, are connected by use of this Point Search embodiment, where the common point of search is a valuable belonging lost by User 1 and found by User 2.

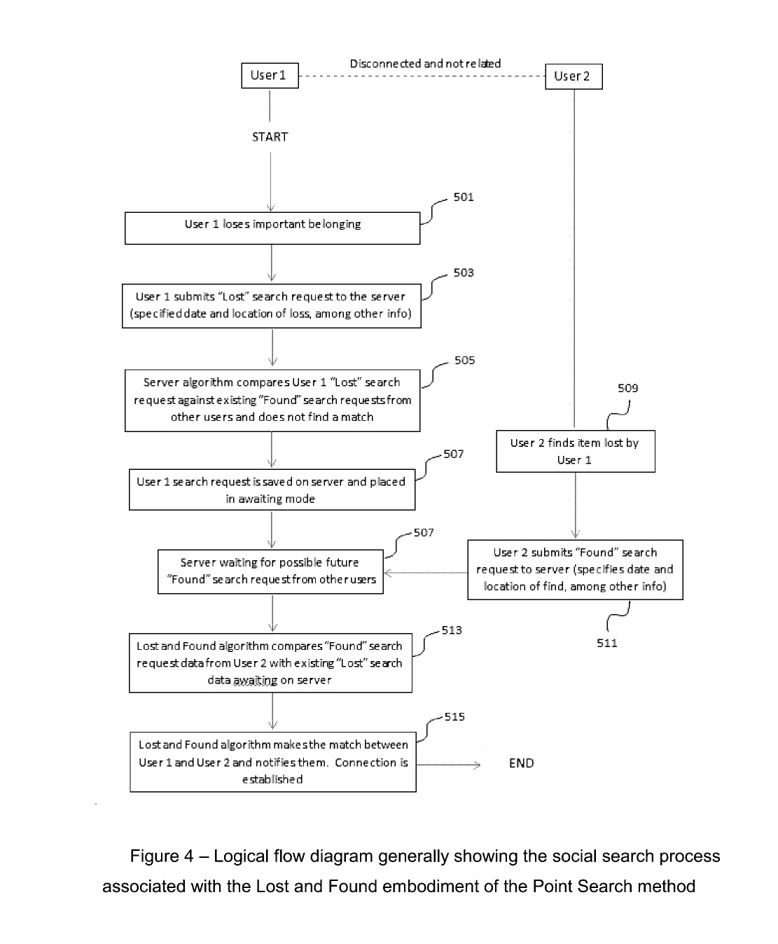

FIG. 4 illustrates the logical flow diagram generally showing the social search process associated with the Lost and Found embodiment of the Point Search method. Referring to FIG. 4, the search process associated with the Lost and Found embodiment includes the following steps:

Step 501: User 1 loses an important belonging.

Step 503: User 1 submits a Lost and Found Point Search request to the server. In the pre-set search fields, User 1 specifies whether the search request is for a “Lost” or a “Found” item (“Lost”, in this case), the date and location of the loss, as well as the type of lost item. Some common item types can be pre-set in the search interface, for which further more detailed pre-set search fields will be open to User 1. If, for example, the item type specified is a pet, further fields open up to User 1 to specify what type of pet, race and eventually other details, such as colour, size etc.

Step 505: The Lost and Found server compares the “Lost” search request data received from User 1 with existing search requests of the type “Found” submitted by other users. Due to the very specific details of the Lost and Found searches, the server can find a match with very high probability of a true connection. In the case of the flow chart presented in FIG. 4 describing the Lost and Found process, User 2 has not yet submitted a “Found” search request and therefore the server will not find a match at this point. If there are still searching matches of a lower level (less likely of true match) found by the server matching algorithm, these can be sorted out by User 1 whether true or false upon further inquiry.

Step 507: At this point, User 1 search request is saved on the server and is placed on “awaiting mode”, waiting for future possible “Found” search requests from other users.

Step 509: User 2 finds the item lost by User 1.

Step 511: User 2 submits a “Found” search request, where User 2 specifies similar data as User 1.

Step 513: The Lost and Found server algorithm compares the search data received from User 2 with the existing search data stored on the server, received from other users. Since User 1 already submitted a Lost and Found search at this point, the algorithm will find a match and notify both users of the match. If the lost item is a pet, it is possible that the date and location specified by User 1 at the time when the pet was lost may not correspond to the date and location specified by User 2 at the time he found the pet. However, the algorithm can take into account these considerations.

Step 515: Upon receiving the message from the server, User 1 and User 2 can exchange messages and the connection is established.

### Embodiment 6

In this embodiment of the Point Search method, herein called Point Classifieds, a user trading an item uses this service to reach out to other users looking for the same item at the other end of the trading process, where the trading items can be any items that are suitable for trading. The Point Classifieds embodiment is a one-to-many type of search, in the sense of the definition provided in the Detailed Description section.

Therefore, for this embodiment of the Point Search method, the common point of the search process is the classified item.

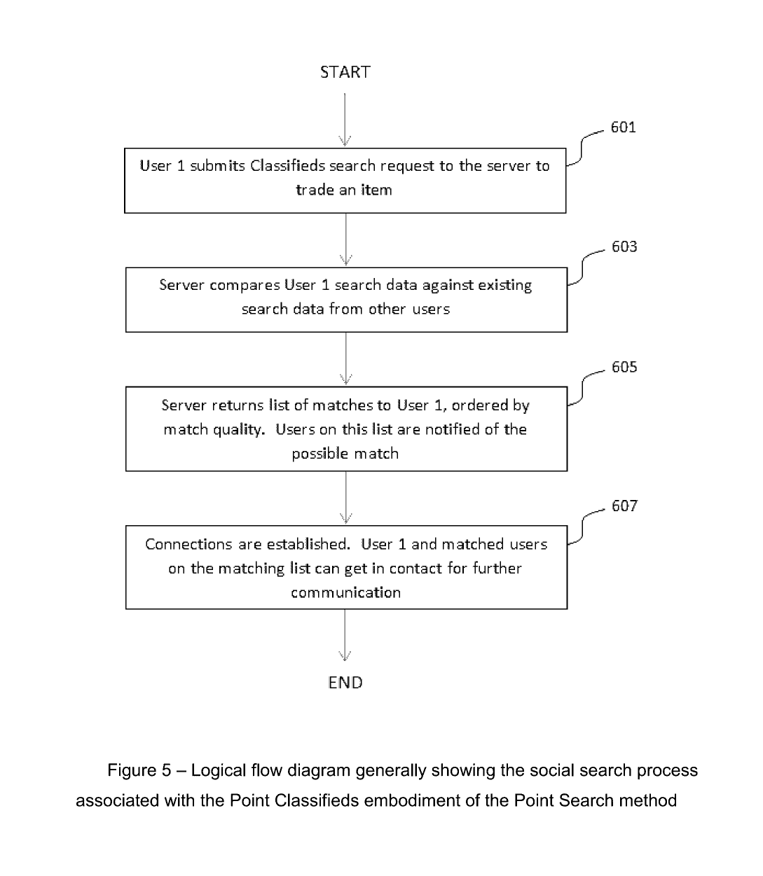

FIG. 5 illustrates the logical flow diagram generally showing the social search process associated with the Point Classifieds embodiment of the Point Search method. There are two distinct situations: (1) a user submitting a search request is looking to trade an item he owns; and (2) a user submitting a search request is looking to acquire an item from other users. Referring to FIG. 5, the search process associated with the Point Classifieds embodiment includes the following steps:

Step 601: Case in which User 1 wants to trade an item. User 1 submits a Point Classifieds search request to the server, in which User 1 specifies, as the most important element of the search, the type of traded item. More details can go into the search request, such as the location of User 1.

Step 603: The Point Classifieds server receives the search request from User 1 and compares it with existing stored search requests from other users.

Step 605: A list of matches, ordered by the quality of the match, is compiled and returned to User 1. Also, the users included in the compiled match list receive a match notification.

Step 607: User 1 and the matching users can get in contact by anonymous messaging to follow up with the trading process.

Step 609: Case in which User 1 is looking to acquire an item from other users—steps are identical as above. User 1 submits a Point Classifieds search request for the sought item. Item type and location of User 1 are submitted as search data, among other possible relevant information.

Step 611: The Point Classifieds server receives the search request from User 1 and compares it with existing stored search requests from other users. A list of matches, ordered by the quality of the match, is compiled and returned to User 1. Also, the users included in the compiled match list receive a match notification.

Step 613: User 1 and the matching users can get in contact by anonymous messaging to follow up with the trading process.

### Embodiment 7

In this embodiment of the Point Search method, herein called Point Map, a user can reach to more previously not related users through a search on a common location identified on an interactive map of the world. The Point Map embodiment is a one-to-many type of search (in the sense of the definition provided at the beginning of the Detailed Description section).

More details about the Point Map embodiment are provided in the next section, “Use, Advantages and Examples”.

### Embodiment 8

In this embodiment of the Point Search method, herein called Point Search for Anything (PSfA), Point Searches can be extended to cover basically any type of search that follows the Point Search basic principle of searching for a common point. To that extent, a user can make a Point Search request on a very generic or a very particular topic, by using any word or phrase of preference. It can be a person, firm, circumstance, discipline, human action, belief, thought, condition, disease, basically anything that a user wants to discuss about with other people that searched for the same thing, the common point of search.

More details about the PSfA embodiment are provided in the next section, “Use, Advantages and Examples”.

The Point Search method described in this disclosure is not limited to the specific embodiments mentioned above. There are other possible instances of the Point Search method that can operate on the same basic principles of this search method as the described embodiments.

### Use, Advantages and Examples

The Point Search Method

Point Search is a generic method for searching between people, whereby the users search for each other indirectly, by use of a common point, where the point can be a circumstance, location, event, among many other. Due to its versatility, this novel technique of searching can reach many different social aspects, hence the variety of the embodiments described in the following paragraphs. By its nature, the Point Search method is very suitable for implementation within a social network.

### Find You Embodiment

The Find You embodiment of the Point Search method can potentially be implemented as an enhancing social feature of a social network with a huge potential for increasing the number of network users and network activity. Find You is a one-to-one application of the Point Search technology (in the sense of the definition provided at the beginning of the Detailed Description section), whereby a person searches for another person in particular, related but disconnected, that would otherwise be impossible to find with the current searching methods. Find You is based on an idea of interaction between people at a level that has not yet been tackled by the existing social networks. Find You can start a totally new trend within the social network that can stir a lot of activity and, as a consequence, position the social network on a strong foothold in the social networking realm.

The Find You embodiment of the Point Search method works in a variety of special situations that basically everybody has experienced and will experience at least several times in their lives.

Find You—Case Study

As an example of the way the Find You embodiment works, a case study will be presented here based on a true story of people reconnection (reunion), in the sense of the Find You embodiment. A woman, abandoned at birth by her mother in a Burger King washroom on Sep. 15, 1986, posted a message on Facebook looking for her mother. She caught a significant attention and the message was shared 30,000 times, spreading it until her biological mother noticed it and finally they connected in a very emotional and widespread media covered story. It needed though a lot of luck for the lady to capture this widespread attention, and a lot of action from the Facebook users. Here is what Katheryn said in a TV show: “It's so surreal; never in a million years did I think this was going to happen”. The Find You embodiment of the Point Search method would make this connection, and any similar others, very easily: mother submits Point Search with date of birth and location (Burger King, Allentown), daughter submits Point Search with same coordinates, and the connection would be done with 100% confidence of a true connection. A ‘one in a million’ event (as the daughter put it) would be almost a certain fact with Find You for a lot of people.

There are countless stories of permanent separation in the world, but without this happy ending, for the vast majority of which Find You would easily make the true connections. The internet is full of reunion stories for the lucky cases that made it one way or another, but the number of disconnected people that don't make a reconnection is far larger. Examples of reunion cases are family reunions (adoption in most of the cases), holocaust or other deportation camps survivors, reunions after war and other distress separations, among many others. But aside of these very special cases of reunion, the Find You embodiment of the Point Search method applies to anyone that had a strong relationship of any kind, anytime in the past, with somebody else, even for a very short period of time, and wants to reconnect. Virtually anybody had at least several such past encounters, which makes the Find You embodiment a feature that is very likely to be widely used once implemented within a social network.

Find You—Long Past Encounters

As an example and not by way of limitation, a specific scenario will be presented to explain how the Find You embodiment would work for long past encounters. In this scenario, User A, sometime a long time ago, met User B that he made a special connection with, for a short period of time under some special circumstances, after which both users returned to their lives and never heard of each other since. It can be a relationship of any nature: love, strong friendship, rivalry, or just circumstantial. It could, for example, be based on a circumstance where User A offered precious help to User B that turned out to be influential for User B's life, and now User B would like to show his appreciation that he feels he didn't fully show at the time of the encounter. Or, on the contrary, it could be based on a circumstance where User A mistreated User B to the point where that circumstance has stuck firmly in User A's memory, together with a feeling of guilt, that User A would feel relieved if he could at least apologize to User B, even after 10 years or more. These are just a few specific examples, but more generic examples can be based on any circumstance that led to a strong relationship of any kind, love probably being the most common of them all. User B could be a person that User A maybe doesn't even remember her name after such a long time, but who turned out to keep her place in User A's mind and heart for the rest of his life for the few magic or very important moments they spent together at the time of their past encounter. As incredible as it may seem, the Find You embodiment of the Point Search method can still make it possible, and even very easily, to get User A in contact with User B again and share those magic moments together, even if they happened 10, 20, 30 or 40 years ago. All both users need to do is a search on the common point of their encounter, for which the date and location would most likely suffice.

For searches back in time with the Find You embodiment, people would look into their memory, make a list of possible connections and make their search requests. Virtually anybody has at least several such encounters. Once User A makes a search request and sends it to the Find You server, three outcomes are possible: 1. If User B already made a search request for User A, the algorithm will find it and the connection will be established right away; 2. If User B has not searched for User A yet, Find You will tell that to User A and the search request will stay there for an indefinite period of time, waiting for a possible search back from User B at the other end. If, at one point, User B searches back for User A, the connection will be made and Find You will notify both users of this connection; 3. User B will never search back for User A, which means that User A's search request, while still waiting, will never be granted a response.

Following is a brief estimate on how many people would have a positive response from the Find You embodiment of the Point Search method, for the long past encounters alone. For a more realistic estimate, populations from locations without internet connection were eliminated from the calculation. If everybody had just one past encounter searching for, then for a total user base of 300 million for the social network hosting the Find You feature, under the assumption that the feature is well established and known within the social network to be used by its users, the probability that the Point Search would be fulfilled is about 10%—that is still 30 million success stories. But if everybody has a list of 5 past encounters on average looking for, then the probability that none would give a positive result is around 60%, leaving a probability of 40% of the network users for which the Find You feature would work for at least one of the 5 long-past encounters. That is over a hundred million users—a lot of success stories. But for a social network of 800 million users, the figures would be much higher, considering the huge user base, and the Find You feature would work for 95% of the users.

Find You—Recent Encounters

As an example and not by way of limitation, a specific scenario will be presented to explain how the Find You embodiment would work for recent encounters. In this scenario, User A just returned from a camp, or vacation, conference, tournament or any other place or event where he met a very special User B that he made a strong connection of some sort with, but for some reason didn't voice that connection enough, and didn't get User B's info to contact later on. Maybe he didn't dare? Maybe he wasn't sure User B was at the same level of connection? Or maybe it was just too quick and they didn't have a chance to exchange contact info? For whatever reason that happened, it would still be possible for User A to get in contact with User B, by use of the Find You embodiment, even if User A didn't know absolutely anything about User B, not even the name. Maybe they haven't even spoken to each other. The only requirement is that both users have to make the Point Search. The coordinates of the search are easy: both users submit the date and location of the encounter in pre-set search fields offered by the Find You user interface of the hosting social network, with optional additional information in form of text strings that would be relevant to the encounter.

Find You—Present Encounters

As an example and not by way of limitation, a specific scenario will be presented to explain how the Find You embodiment would work for present encounters. In this scenario, User A is at the present moment in a place, possibly a crowded place, where he noticed User B he never met before, and User B noticed User A back. There's a sudden strong connection, but for some reason they can't talk to each other. The Find You embodiment of the Point Search method can help User A and User B get in contact right there. A specific hypothetical example of the use of the Find You feature for present encounters is presented as follows.

User A is in a restaurant with his friends. A few tables away there is unrelated User B with her friends. At this point, Users A and B are unrelated and disconnected. User A and User B make eye contact, and there is a sudden strong mutual interest in each other. Unrelated Users A and B become now related, but they are still disconnected. Approaching right there would be too direct though, and inappropriate. In the old days, people would eventually use to send a written note, or a verbal message, through the waiter. But User A has his phone, and User B has hers. After repeated instances of eye contact, User B starts tapping on her phone. With a well established and well known Find You feature, User A might hope that User B is making a Find You search for him, so User A tries his luck and signs in to the social network hosting the Find You application. The easy Find You user interface helps User A make a search request in just a few taps (for present connections, like this one, requesting a Point Search by just providing the precise GPS location automatically by user's phone would be enough). If User B did the same search on her account, a connection would be established right away and the Find You server would notify both users. Once the connection is made, they can follow up with anonymous messaging through the interface provided by the Find You application. Users A and B become now related and connected.

Find You—Continuing Encounters

As an example and not by way of limitation, a specific scenario will be presented to explain how the Find You embodiment would work for continuing encounters. In this scenario, User A and User B know each other. User A has special feelings for User B, but User A refrains from confessing these feelings for various possible reasons. Maybe he is not sure the feelings are 100% mutual, or maybe the social circumstances stop him from confessing. Or maybe each of them waits for the other one to make the first step. By the way it works, the Find You embodiment of the Point Search method can overcome these obstacles.

Find You—Future Encounters

But the Find You feature of the Point Search method can work on future encounters too. The difference from the other Find You types of encounters presented above is that, for the future encounters, the Find You feature is a one-to-many type of search (in the sense of the definition provided at the beginning of the Detailed Description section), in which User A searches for users that he is not yet related to. Let's say User A plans and eventually already scheduled a future event: a vacation, a conference, a camp, a trip of any sort, an expedition, a reunion, a game, a social event, anything. User A may want to connect with people that will do the same thing, so User A can share impressions, such as knowledge, concerns, ideas for activities or just opinions of any sort. If during this virtual encounter User A connects with some of these people at a higher level, User A may even want to meet these people in person when the time for this common future event comes, since they will be at the same location at that same time, doing the same things. One big advantage of this type of future encounters is the convenience: it only takes one minute for a user to submit a Point Search. User A specifies the location and the time period he will spend at that location. If other users already sent this Point Search, User A will see them right away and can get in contact. Whenever a new user makes the same Point Search, a notification will be sent to all users that already made the search, so they can come back and connect. Discussions can be in public, or in private.

In all cases of the Find You embodiment described above, except for the future encounters case, User A searches for specific related User B through the Point Search feature of the social network he is using, in a one-to-one type of search. But the question remains: would User B search back for User A? One necessary condition is that User B needs to know about the Find You feature and she has to be willing to use it to search for User A. If the moment was for User B as magical or important as it was for User A, then it's likely that User B would search back and the connection would be easily made. But if it wasn't, then the connection is not strongly mutual and then there is no point for a contact. This is a positive feature of the Find You embodiment, because it only works on true mutual connections.

There may be many other circumstances not presented here in which two people that are strongly related cannot get in contact with each other with the current capabilities of the existing social networks. The idea behind Find You is very simple: it has to be a Point Search in form of a mutual search, in which both parts of the relationship search for each other. Once this is done, the connection is almost surely established.

One great inherent characteristic concerning privacy that the Find You feature exhibits is the fact that the confession between the two users has to be mutual. It is a Point Search, a two-way focused search on a common point. A one way unfocused search from User A doesn't reach User B, unless User B searches back and the connection is established. This way, the searching User A doesn't have to worry what the sought User B thinks about him if User A searched for User B but User B didn't want to search back, because User B will never know that User A searched for her. Only when User B searches back on User A, if that happens, the connection is made and both users are notified of the connection. By the way it works, this simple feature naturally addresses any privacy concerns, and breaks a great psychological barrier between people that many times stops them from connecting. One sided connections that are not wanted or looked for at the other end remain private and just don't make it.

Lost and Found Embodiment

The Lost and Found embodiment of the Point Search method is a one-to-many type of search (in the sense of the definition provided at the beginning of the Detailed Description section), in which a user reaches out to more disconnected and previously unrelated users with the purpose of finding a lost item.

As an example and not by way of limitation, the particular but very common case of lost pets is discussed, in the sense of the Lost and Found embodiment of the Point Search method. By the intrinsic nature of the Point Search technology, it is a perfect fit for lost and found cases. A study shows that 15% of all dog and cat owners in the US have lost one in the past 5 years, and a significant fraction of those never found their pet. That amounts to over one million cases every year in the United States alone. If the pet is found by anyone, a Lost and Found Point Search on hosting social network will very easily make the connection provided that both users know about the Point Search method and use it. The owner that lost the pet most surely will use the Lost and Found service to make a Point Search request with exact date of loss, location, together with just a few details about the pet—race will suffice, but other physical characteristics can be specified in the search, such as colour. If the person that finds the pet does the same search, the connection is made immediately.

Location Point Search Embodiment

Location Point Search is another embodiment of the Point Search method. Location Point Search is a one-to-many type of search (in the sense of the definition provided at the beginning of the Detailed Description section), in which a user searches out for more disconnected and unrelated users. Because the circumstances it requires are based on user location, it can run on smart phones or any wearable devices (e.g. glasses, watches etc.) with location capability such as GPS. As an example and not by way of limitation, the following particular circumstances are discussed to exemplify the Location Point Search embodiment.

User A is on the street and he wants to ask something—maybe he is lost and looking for directions, or he needs some clarifications, or just wants to discuss about the surroundings. User A can make a request, or ask a question, verbally or in writing through his phone or wearable device, and the request is sent to the Location Point Search server, together with User A's location information collected automatically from the device GPS. If other users in User A's area have the Location Point Search feature on on their device, they will receive a notification from the Location Point Search server that some other user (User A) made a request. The Location Point Search server knows these users' location, because, by having their Location Point Search feature on, their device sends their location information to the server at regular intervals, for example once a minute. A User B receiving User A's request may decide to answer it or not. The answering User B can send his answer back to the server so the questioning User A can receive it from there (by hearing it, for example, if User B's message was verbal), or the answering User B can initiate the direct communication with the questioning User A for a live chat. More users can send an answer to the server, so the questioning User A is notified by his device, through the Location Position Search server, that he has more offline answers so he can read/listen them in sequence. Chats can be one-to-one, or in group.

Each user sets his Location Point Search to receive or send messages within a specified radius around him. A reasonable default value could be 100 meters, but users can reset it at a desirable value. But surrounding areas can also be defined by other criteria. If the User A is in a public place such as an arena for a basketball game, he can set the area of interaction to within the perimeter of that arena. The Location Point Search application has this information from the embedded Maps application, so based on User A's GPS data, the Maps application can determine if other users are within the arena perimeter. This way, people participating to common events, or under common circumstances, can get in touch through the Location Point Search feature. Public places can be stadiums and arenas for sport events and concerts, or any other social event; a mall; a highway; a theatre, restaurant, dance club; institutions; and so on, virtually any public place that is recognized by the Maps application.

A very special trend for people communication can be started using the Location Point Search. People under similar circumstances (shopping in a mall, having dinner in a restaurant etc), or participating to the same social events (sport games, concerts etc) have a lot in common at that particular time: they are doing the same thing. This makes it very easy to open a communication line between people that otherwise would never get in contact with each other. Social events, such as a sports event, can become even more social by connecting people with the Location Point Search feature.

Possible uses of Location Point Search are not limited to the ones mentioned so far. It can have a whole range of applications. Location Point Search opens a new different way of communicating between people, based on live activities with people participating at same events in a same location and at the same time.

Distress Search Embodiment

The Distress Search embodiment of the Point Search method applies to missing people, in a variety of situations: abducted people, natural disaster response (earthquakes, hurricanes, tsunamis), social unrests, epidemics, amnesia or other mental illness, or people missing for an unspecified period of time for whatever reason, that lost contact with close ones. The Distress Search embodiment can help in all these situations, if both parts of the relationship are willing to search for each other. The Distress Search is a one-to-one type of search, in which related but disconnected people search for each other.

For the humanitarian cases, the search service should be provided to anyone in need, so a social network account should not be required. In temporary situations of disaster response, the Distress Search service for missing people could be embedded right in the main web page of a search engine, such as Google. Given the huge exposure of Google's main search page, no recovery agency can work more effectively than this, for example in disaster crisis response.

Case Study: Distress Search for Ebola Outbreak

October 2014—the first cases of the Ebola virus in the US. One infected person took a flight within the United States a day before the symptoms appeared. Given this short interval, it was a great concern that the person carrying the virus might have spread it to other flight passengers. The authorities seek to contact all passengers of the same flight as the infected person.

For this case, the Distress Search could apply in a very useful way. All passengers would submit a point search to the Distress Search server, with input as time of flight and flight number, and that would put everybody in contact immediately in one common location within the Distress Search webpage. The authorities would of course use the same point search to contact these people, and discussions can go right there, with all needed details. This way, there would be no need for the passengers to search the internet to find a website where this kind of data might be centralized, or where to contact the authorities. If Distress Search was a well-established and known feature, people would use it right away as the most effective way to connect. They could provide further information as to what later locations these people went to, and that would help authorities to get valuable information and draw a map of first or second degree encounters in their efforts to try to contain the virus. Given the fast response needed in such situations, the effectiveness of the Distress Search could prove vital, especially in comparison with the actual efforts and precious time wasted by the authorities to contact every flight passenger and put the data together, as it was the case in the absence of the Distress Search service.

Point Classifieds Embodiment

The Point Classifieds embodiment of the Point Search method is a one-to-many type of search (in the sense of the definition provided at the beginning of the Detailed Description section), in which one user searching for an item (for buy/sale, rent or trade purposes) reaches out to many disconnected and previously not related users that might return the search at the other end of the Point Search process. Just as for Lost and Found, the Point Search method works perfectly for the buy and sale process for virtually anything. The Point Classifieds embodiment eliminates the need for advertising (in newspapers, physical places or online), for endless searches on eBay Classifieds (kijui), AutoTrader or any of the sort. The focused search is performed at both ends, with more or less specific details into the search, as opposed to the current divergent one-end searches from either end that are hard to find at the other end.

The same arguments hold for renting a place, trading or exchanging goods, exchanging homes (house swap) etc. This sector alone covers a huge amount of searching and completing transactions, which would have huge implications on the social network activity, if it were to be implemented within it.

Point Map Embodiment

The Point Map embodiment of the Point Search method is a one-to-many type of search (in the sense of the definition provided at the beginning of the Detailed Description section) by which a user can reach to more previously not related users through a search on a common location identified on an interactive map of the world. Although the Point Map embodiment can be implemented within any social network by using an embedded map technology, the Point Map method is described herein with reference to the existing Google Earth technology, by way of example.

The way Google Earth is currently used gives the user a feeling of isolation, by which the user wanders the globe alone, with no social interaction at all. The Point Map method offers a feature by which a searching user can click on a preferred location on the map, and the Point Map application displays, in return, the number of users (and a list of them) that visit the same area at the same time with the searching user, and therefore it offers the capability for these users to connect with each other, which would give the users a strong social feeling and the possibility for interaction. The Point Map is therefore a Point Search on a common point, where the point is the location on the map visited by the users.

By way of example of an implementation of the Point Map embodiment, but not limited to it, when a user views an area in Google Earth, a small label in the corner of the viewing area shows how many users are currently viewing that area, at the same level of zoom as the searching user. The larger the area is viewed, the more visiting users are displayed to the searching user, but the less specific the viewing area is. When the searching user zooms in to a selected area, the number of users currently viewing that area gets smaller, because a smaller area is covered. The closer a searching user looks at the preferred location on the map, the fewer users are viewing that area, but the more specific the area (point of search) is, so the more focused a possible discussion between the connecting users would be. Even a spatial distribution of the visiting users can be shown to the searching user, so areas currently being more visited can be easily spotted. Upon connecting with each other, users can interact in chat sessions about specific areas. A list of the current viewers visiting the same area can be displayed to the searching user upon clicking on the label showing the number of current viewers. If the visiting users are signed in with the hosting social network (in this case Google+), they can be shown to the searching user with their credentials. If the visiting users are not signed in, then they can appear to the searching user as anonymous. Discussions can be carried out in separate chat windows, or they can be embedded within the social network if an account is required for this feature. As a particular way of using the Point Map, anonymous searching users that don't have a social network account can see the visiting users and can see their discussions, but they cannot participate in these discussions or in other social interactions within Google Earth. Participating in these social interactions would therefore require network sign in or sign up. If these social features of the Point Map method become popular, they can bring in more network subscriptions.

The Point Map method offers excellent opportunities for discussions between users. People usually search Google Earth for areas they are interested in—these can be areas they either visited, or want to find out about—so they can share information. People meeting in certain places on Google Earth with the Point Map method already have something very specific in common: they like to visit the same place. This commonality makes them more alike, and therefore related, at least for the moment, and therefore more likely to enter communication. With a handy list on the screen with users visiting the same very special area on Earth, chances for entering communication are high.

Point Search for Anything (PSfA) Embodiment

The Point Search method is not limited to the embodiments and examples presented above. With the PSfA embodiment, Point Searches can be extended to cover basically any type of search that follows the Point Search basic principle of searching for a common point. To that extent, a user can make a Point Search request on a very generic or a very particular topic, by using any word or phrase of preference. It can be a person, firm, circumstance, discipline, human action, belief, thought, condition, disease, basically anything that a user wants to discuss about with other people that searched for the same thing, the common point of search. The PSfA is therefore a one-to-many type of Point Search (in the sense of the definition provided at the beginning of the Detailed Description section), where a user reaches out to other disconnected and previously unrelated users searching for the same topic, eventually at the same time, and where a discussion group can be joined, or a one-to-one discussion can be carried out with individual users. People's curiosity will push them to make all sorts of searches on any ideas or topics, and they would like to know if other people think at the same topic, eventually at the same time, so they can connect based on the common point (interest) of their search.

The use of PSfA results in two different types of connections: live connections; and delayed connections. In live connections, a current PSfA search request sent to the PSfA server by User A returns the users searching for the same common point at the same time with User A, within a defined range of a few minutes, or for as long as the users searching for the common point appear online within the network. This way, users searching for the same common point can get in contact live. In delayed connections, users finding each other based on the common points of search are not concurrently online. For the delayed connections to be possible, the PSfA server would have to store users' searches.

As an example of use of the PSfA, and not by way of limitation, people would search for very specific topics or personal thoughts, just out of curiosity to see if anybody else thought about that. Once User A makes a search, he has the choice to discard that search or to keep it in the pool as ‘active’. If discarded, User A's search will not be visible to other users and User A cannot be reached by other users searching for the same thing, but User A could still be notified if other users searched for that topic, if he opts for it. User A will have a history of all his searches, classified as ‘discarded’ or ‘active’, and under each search, information as to how many users (for discarded searches) and who (for active searches, as anonymous users) searched for the same common point, or something similar. The list of findings for a particular search will be organized either based on relevance (how close the search keywords are to each other), or by time of posting.

For PSfA searches, identity will be kept private so the users can interact without exchanging their identities, although their activity is carried out within the hosting social network accounts. Users will be assigned default generic usernames automatically for PSfA purposes, such as User324. Anonymity will facilitate communication without the concern that a user's identity is revealed. Unless users enter close one-to-one communication, they are not interested in other users' identity. But if a user opens a one-to-one communication line with another user, they may of course mutually agree to make their identity known to each other. On the other hand, abusive users can be reported, even though their identity is not known to the other users. Their activity within PSfA is still made through their social network accounts, since the PSfA is a feature of the hosting social network, so they still bear accountability for their online actions.

The PSfA will work for a huge variety of topics, or common points of search. Just a few examples of the application of the PSfA method are presented here, and it is understood that the application of PSfA is not limited to these examples. For another example, a user would be interested to make a virtual musical band with others looking for the same thing. Or he can look to share a weird idea for possible collaboration. Discuss about a disease or condition. Or about a feeling or thought he has at the very moment of searching. People might just be curious to see if other people think alike. Alternatively, some people might want to see if other people think about the same thing or have a same feeling, at the same time. People with a current miserable mood, for example, might want to talk to others in a same mood at the same time—this might help them get their motivation back. While in a bad mood, it helps people to know they are not alone, and many people might want to reach for others when they are down and everything seems to go wrong lately. For this purpose, discussing a mood, a feeling or a momentary thought will be live discussions, because people need to talk about it ‘now’, when they have that temporary mood, not later. Mood is a very important and present aspect of people's lives, accompanying people in all their daily activities or routines, but it is not given its deserved attention. For this reason, a section for Searching for Mood can be made available separated for live discussions, where generic moods will be made available to pick from a pre-filled list when making a search for online people experiencing the same feelings at the same time. For example, an item on the list of moods can be “Heartbroken—my girlfriend dumped me”. Of course, more specific custom searches by words can be made by the users. Also, a list of word searches made by users that are still online can be made available to a user using the Search for Mood section. And of course, a user can make his/her own search and potentially connect with other users making the same or very similar search.

Part of the PSfA is about users' interests, feelings and imagination. And where are a lot of users, such as in a social network, there will be a lot of common interests and feelings. The PSfA will play the role of all message boards and more, in one place, with additional advantages of convenience, instant connection with users of similar interests, anonymity. The search can have other optional fields to fill in, such as location, since some users might be interested to interact only with users within a specific geographic area.

Alternatively, given its wide area of search, the PSfA could be implemented directly within an existing web search engine, such as Google, Yahoo or Microsoft. Although still tied to its affiliated social network, PSfA point search requests can therefore be performed by users in the web page of the search engine in the same way a normal web search is performed. By way of example, Google processes about 2.5 million searches every minute. At this volume of search, odds are that pretty much everything a user searches for was or will be searched for as a common point within a few minutes by other users. This way of using the search engine, by performing Point Searches, opens up a totally new and different dimension of the search process, in which the social element is heavily involved. Among many types of searches, spontaneous searches based on common points such as momentary moods will be performed by the users on a massive scale, at least out of curiosity, if not something else, for example just to see how many users think at the same thing at the same time, and eventually to follow up with discussions from there. Or, for just a very particular example, if an idea to make a band online crosses a user's mind at one point, the user would just search for something like “Let's make a band online” and there will be a good chance that out of the many millions of searches, somebody looked or will look for this common point within just a few minutes, with the potential for interaction between the related users. Once such a search is performed, the results page displays how many similar searches were performed within the last minute(s), but the page can also display to the user, after his search, how many more users search for something similar during, say, one more minute after his search. The implementation of the PSfA directly within the web search engine unleashes the extraordinary potential power of the huge amount of searches being made, that are not currently taken advantage of by the search process.

The PSfA feature can be very discreetly implemented in the general web search process, so it would not interfere too much with the way people normally use to search the web. When a user performs a search with the main Google search page, for example, for a certain word or group of words, the search results page can provide, aside of the results it normally provides, information as to how many people are currently searching (within, for example, the past 5 minutes) for the same common point (word, group of words, or similar words), together with the number of users that are currently engaged in a discussion on the searching topic, if there are such discussions, so the user can join these discussions (by using a provided link). This way, a discussions page will be opened in a different window so it would not interfere with the search results page. Also at the top of the search results page, there can be a link “Ask a question” where the user can ask a question or initiate a discussion about the current search, if for example there are no current discussions on that topic. Therefore, the PSfA point search only implies a subtle diversification of the web search process, as conducted by the users. Currently, web search page such as Google is used to search the net mostly for information. With the PSfA functionality added to it, the social side of the net can also be searched for, but this functionality will be totally non-intrusive and almost invisible to the user, as the main search page would look exactly the same.

The big advantage of the PSfA is that the users do not necessarily need to look for categories where to place their searches. Their searches will reach other users with similar searches on common points based on the content of the search. Users will resort to the PSfA for any other searches for people that cannot be made with the more dedicated ones described above, such as Find You, Location Point Search, Missing People, Lost and Found, Point Classifieds, or others. PSfA are very generic searches that can still be very focused at the same time, through the search text itself. A search on a more generic point will give a lot of common returns, but not very focused. The more detailed and specific a point search is, the fewer but more focused the common findings are.

Although the present invention has been described in considerable detail with reference to certain preferred embodiments thereof, other embodiments are possible.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented by at least one computer device, the method comprising:
(a) storing elements of search requests submitted by users of a social network service searching for other users, whereby:
(i) the search requests submitted by the searching users may be for specified known users or for unspecified unknown users;
(ii) the searching users and the users being searched for do not have direct contact information for each other within the social network or otherwise;
(iii) the stored search requests submitted by the searching users are not communicated by the social network service to the users being searched for, and
(b) performing comparative analyses of the stored searching elements submitted by all users, between any two users, to establish connections by means of the social network only between the users of the pairs for which a matching criterion is satisfied based on found commonalities of the searching elements as submitted by the two users of the pairs being connected.

2. A method of claim 1, wherein the searching users and the users being searched for know each other.

3. A method of claim 2, between two pairing users, wherein:
(a) the first user of the pair submits searching elements in search for the specified second user;
(b) the second user subsequently and independently submits searching elements in search for the specified first user, in which case the search is mutual,
the method providing notification to both users of the pair of a possible true connection between the two users if the said matching criterion is met.

4. A method of claim 3, wherein the stored common searching elements, as submitted by both users of the pair searching for each other, are based on the common circumstances and events of an encounter between the two users that led to a mutual relationship of any sort that unfolded and concluded sometime in the past.

5. A method of claim 3, wherein the stored common searching elements, as submitted by both users of the pair searching for each other, are based on the common circumstances and events of an encounter between the two users leading to a mutual relationship of any sort that is unfolding at the present time.

6. A method of claim 2, wherein:
(a) a searching user submits search elements in search for multiple specified users;
(b) the searching user and the users being searched for have a mutual relationship developed within a group comprising of these users, whose events unfolded and concluded sometime in the past;
(c) the users being searched for subsequently and independently submit search elements in search for the specified searching user, in which case the search is mutual,
the method providing notification to the searching user and the users being searched for of a possible true connection between these users if the said matching criterion is met.

7. A method of claim 1, wherein the searching users and the users being searched for do not know each other.

8. A method of claim 7, wherein:
(a) a searching user submits search elements in search for unspecified multiple users;
(b) the users being searched for by the searching user subsequently and independently submit search elements in search for other unspecified users,
the method providing notification to the searching user and the users being searched for of a possible true connection between these users if the said matching criterion is met.

9. A method of claim 8, wherein the stored searching elements, as submitted by the searching user and the users being searched for, are based on common circumstances or events for these users that existed or unfolded sometime in the past.

10. A method of claim 8, wherein the stored searching elements, as submitted by the searching user and the users being searched for, are based on common circumstances or events for these users that currently exist or unfold at the present time.

11. A method of claim 8, wherein the stored searching elements, as submitted by the searching user and the users being searched for, are based on common known circumstances or events for these users that are scheduled to exist or unfold sometime in the future.

12. A method of claim 8, wherein the stored searching elements, as submitted by the searching user and the users being searched for, are based on lost personal items of the searching user.

13. A method of claim 8, wherein the stored searching elements, as submitted by the searching user and the users being searched for, are based on classified personal items for sale or buy of both the searching user and the users being searched for.

14. A method of claim 8, wherein the stored searching elements, as submitted by the searching user and the users being searched for, are based on geographic locations specified on interactive maps by both the searching user and the users being searched for.

15. A method of claim 8, wherein the stored searching elements, as submitted by the searching user and the users being searched for, are based on a variety of circumstances leading to missing people, such as: abductions, natural disasters (earthquakes, hurricanes, tsunamis), social unrests, epidemics, amnesia or other mental illness, or people missing for a certain period of time for any other reason, that lost contact with close ones.

16. A method of claim 7, wherein a searching user submits search elements, by use of a mobile device, in search for multiple unspecified users that share the same approximate location at the same present time with the searching user, the method comprising:
(a) providing instant notification of the searching user's search request to the neighboring users, by way of a mobile device and based on the location capabilities of the mobile device; and
(b) responsive to the confirmation of the user being searched for by the searching user and approval of a connection, providing a communication line between the searching user and the confirming user being searched for.
